(19) United States
(12) Patent Application Publication
(10) Pub. No.: US 2010/0114741 A1
(43) Pub. Date: May 6, 2010

(54) SYSTEM AND METHOD FOR PROVIDING AN IMPROVED DATA SCHEMA VIA ROLES AND USES

(76) Inventors: Dennis Adama, Grand Rapids, MI (US); Reid J. Smeda, SR., Ada, MI (US); Gregory Brander, Zeeland, MI (US); Keith McCreery, Rockford, MI (US)

Correspondence Address: PILLSBURY WINTHROP SHAW PITTMAN, LLP, P.O. BOX 10500, MCLEAN, VA, 22102, US

(21) Appl. No.: 12/262,899

(22) Filed: Oct. 31, 2008

(51) Int. Cl. G06Q 10/00; G06F 17/30; G06Q 40/00; G06F 7/20

(52) U.S. Cl. 705/30; 707/E17.046

(57) ABSTRACT

A system and method for providing an improved data schema for representing financial transactions using data relationships based on financial transaction information is provided. Instead of relying on financial transaction documents for financial transaction information, the underlying data and their relationships are used to represent the financial transaction information. For example, each entity involved in a financial transaction may be represented separately. Furthermore, each entity may be associated with a role played by the entity in the financial transaction and entity type that describes the type of entity. Relationships in which the entity may be involved may depend upon this and other information. In this manner, for example, financial transaction information from a loan application document may be used with financial transaction information from a deposit account document in order to generate another financial transaction document even though the loan application document uses different terminology than the deposit account document.

### FIELD OF THE INVENTION

The invention relates to systems and methods for providing an improved data schema for representing, transmitting, processing and/or retrieving information for a variety of transactions.

### BACKGROUND OF THE INVENTION

Individuals, businesses, government, and other parties execute a wide variety of transactions. These transactions are often documented or papered with various transaction documents, including but not limited to contracts, agreements, disclosures, schedules, and/or other transaction documents. Transactions may have a variety of transaction types including, but not limited to, deposit accounts, Individual Retirement Accounts, consumer lending, commercial lending, mortgages, and other transaction types. Each transaction may involve various types of transaction activities such as opening an account, applying for a loan, dealing with government regulations, or other transaction activities. Automated processes for completing a transaction activity may require gathering transaction information associated with the transaction and populating transaction documents with the transaction information. Representing, compiling, transmitting, processing, and/or retrieving transaction information may make the gathering process time consuming and expensive.

Often one type of transaction may require some transaction information that is similar, and possibly identical, to transaction information required by another type of transaction; whereas some transaction information may be entirely different between two types of transactions. For example, a party may be involved in a consumer lending contract with a commercial lender that requires transaction information relating to the regulatory environment affecting the contract. The same party may also be involved in a commercial lending contract with a commercial lender that may not require any transaction information relating to the regulatory environment. Here, the consumer lending contract and the commercial lending contract may have some similar transaction information such as the identity of the party and some different transaction information such as transaction information relating to the regulatory environment.

The transaction documents may include transaction information in separate documents or include transaction information in the same document, in either case in one or more formats. This may also make representing, transmitting, processing, and/or retrieving transaction information problematic.

Because various categories of transaction information may be loosely defined by transaction documents, transaction information representing a certain regulation that affects a contract, for example, may not be categorized as transaction information related to a particular regulatory environment. Thus, only those familiar with the contract may be able to identify the transaction information as pertinent to the regulatory environment. This may also make storage, compilation, and retrieval of this transaction information problematic.

Many types of transactions require the same or similar transaction information yet use different terms or data fields to define, describe, reference, organize and/or store the data. In some cases, the same or similar transaction information may be stored in data fields having different names. For example, an identity of a person applying for a loan may be referred to in a data field called “borrower” in a loan application, a data field called “mortgagor” in a mortgage application, and a data field called “account holder” in a deposit or retirement account document.

Furthermore, a particular transaction may require transaction information that is redundant. For example, a loan application may require the identity of the borrower applying for a loan as well as the identity of the account holder who is putting up collateral for the loan even though the borrower and the account holder are the same person. In this case, existing systems and methods may require entering information related to the identity of the loan applicant (among other information related to the loan applicant) and the identity of the account holder (among other information related to the account holder) even though the entered information is the same. Thus, the identity of the person, for example, is made redundant in existing transaction data schemas. Additionally, a loan processor, for example, would have to redundantly enter this data, increasing the chances for error. These problems often lead to inefficiencies, making representing, transmitting, processing, and/or retrieving transaction information problematic.

These and other problems often persist because existing systems and methods focus on transaction documents for the transaction information instead of focusing on the transaction information itself. Lending institutions, for example, may store and rely upon loan application documents instead of the underlying transaction information and relationships described therein. As a result, transactions of one type are typically represented independently of transactions of another type, which makes using transaction information from one transaction to another difficult even though they often share similar information.

Existing systems and methods suffer from these and other problems.

### SUMMARY OF THE INVENTION

The invention relates to systems and methods for providing an improved data schema for representing, transmitting, processing, and/or retrieving information for a variety of transactions. According to various implementations of the invention, transaction information may be received and represented in a hierarchical data structure. The hierarchical data structure may include some or all transaction information that is required to complete one or more transaction documents related to a transaction. As such, the hierarchical data structure may be used to automatically populate standard transaction documents with the transaction information necessary to document or paper a transaction.

According to various implementations of the invention, the data schema may organize the transaction information into one or more information categories. The one or more information categories may be used to efficiently organize the transaction information to facilitate completing the transaction. The information categories may reflect real-world use and application of the transaction information. In other words, the data schema focuses on the underlying transaction information rather than the transaction documents.

According to various implementations of the invention, the one or more information categories into which transaction information is organized may include, for example, Entities, Underwriting, Collateral, Terms and Provisions, Regulatory, Administrative, and/or other information categories. The Entities category may describe parties involved in, associated with or related to a transaction. The Underwriting category may describe criteria affecting the transaction, such as criteria affecting whether to extend credit for a loan application, for example. The Collateral category may describe collateral that is used to secure the transaction. The Terms and Provisions category may describe terms and provisions related to the transaction. The Regulatory category may describe information related to the regulatory environment of the transaction, including but not limited to federal, state, and/or local disclosure requirements for example. The Administrative category may describe administrative rules, such as institution specific rules, related to the transaction.

According to various implementations of the invention, the one or more categories may define a top level of the hierarchical data structure for transaction information.

According to various implementations of the invention, the hierarchical data structure may include one or more data elements. The data elements may describe data related to the transaction. The data elements may be part of or be categorized in an applicable category. Data elements may include other data elements that are nested and further describe or pertain to the parent data element. In this sense, one data element may describe another data element. According to various implementations of the invention, data elements may also be combined or otherwise used together to enrich transaction information.

According to various implementations of the invention, the data elements may include an “entity” data element. The entity data element describes a party, such as a mortgage applicant, related to the transaction, such as a mortgage.

According to various implementations of the invention, the data elements may include a “role” data element. The role data element may describe a role played by another data element. For example, a mortgage applicant who has an Entity Type “Individual” may have a role of “Borrower” in a transaction related to a mortgage application.

According to various implementations of the invention, the data elements may include an “Entity Type” data element. An Entity Type describes a type of entity such as, for example, “Individual,” “Corporation,” or other type of entity. The Entity Type may help identify and/or classify an entity involved in a transaction.

According to various implementations of the invention, the data elements may include a “location use code” data element. A location use code is used to relate location information of a data element. For example, location information for an entity of Entity Type “Individual” described by a location use code “Primary” indicates that the location information relates to a primary mailing address for the entity.

According to various implementations of the invention, when nested and combined with other data elements, transaction information may be controlled by restricting or allowing combinations of data elements. For example, certain combinations of roles and Entity Types may be restricted. An entity described by Entity Type “Individual” may not be described by a role of “FinancialInstitutionBranch,” for example, because an individual would not be described as having this role. Furthermore, according to various implementations of the invention, certain combinations of roles and Entity Types may be permissibly allowed. In various implementations of the invention, certain combinations of roles and Entity Types may be mandatory when certain roles or certain Entity Types are used. As another example, use of a location use code may vary depending on the entity associated with the location use code. Furthermore, use of particular location use codes may be restricted to certain roles of an entity. For example, location use code “PrincipalResidence” may be restricted to Entity Type “Individual.” Furthermore, location use code “PrincipalResidence” may be further restricted to Entity Type “Individual” if the entity has a role of “Borrower.” Other restrictions and allowances are contemplated.

According to various implementations of the invention, a data element may be used to reduce the redundancy of transaction information for a transaction. The result is a many-fold reduction in the number of data points that is mapped to by users of the hierarchical data structure and a concomitant reduction in the number of data that is entered by a party when processing and/or executing a transaction. For example, data entered by a financial institution may be minimized when processing a transaction such as originating a new loan, opening a new account, and/or other transaction.

For example, roles may be used, inter alia, to reduce the number of data points that are mapped to by a financial institution or other entity using the hierarchical data structure. A transaction may require certain data related to the parties to the transaction to be captured and processed. Such data often includes, for example, an identity of a party, street address, city address, state address, zip code, various phone numbers, and/or other data. Furthermore, each party may serve various roles in the transaction. For example, a party may be the applicant, who is also the borrower, who, in turn, is also the mortgagor. According to various implementations of the invention, instead of redundantly storing/capturing information related to the applicant, borrower, and mortgagor, this information is captured once by using roles. The role data element, for example, may reduce the transaction information associated with the entity data element. In this example, the applicant, borrower, and mortgagor are assigned an entity ID. The role data element is not limited to the entity data element. Various collaterals, for example, may serve one or more roles within a credit transaction. Other data elements may similarly be used to streamline the hierarchical data structure.

According to various implementations of the invention, the hierarchical data structure may represent the transaction information in a uniform manner. Therefore, transaction information from one transaction may be compiled, stored, and retrieved for use in another transaction that would otherwise refer to the transaction information differently. In other words, various implementations of the invention may enable transaction information related to one transaction to be used with another transaction having the same or different type. Transaction information may be received from a variety of sources of information related to transactions such as from transaction documents, transactions databases, transaction forms, and/or other sources of transaction information. Transactions may be related to, for example, deposit accounts, retirement accounts, consumer lending, commercial lending, mortgage, and/or other transactions. Transaction information may include, for example, the identity of a person applying for a loan, personal information of the person, the identity of a banking institution making a loan, employer identification of the banking institution, and/or any other transaction information.

For example, the identity of an account holder for a deposit account may be referred to as an “account holder.” The transaction information related to the deposit account (including the identity of the account holder) may be received and uniformly stored. The account holder may subsequently apply for a mortgage. Execution of the transaction related to the mortgage application may include generating a mortgage application document. A lending institution may identify a mortgage applicant on a mortgage application document as “Borrower.” Uniform storage of the identity of the account holder enables executing a transaction related to the mortgage application even though the mortgage application may identify the account holder as “Borrower,” for example. Accordingly, transaction information from the deposit account identifying the “account holder” may be used to identify the individual applying for the mortgage as “borrower” in the mortgage application document. Other examples are contemplated. For example, transactions may be the same type of transaction but refer to transaction information differently. A first mortgage transaction may refer to the identity of a borrower as “applicant” while a second mortgage transaction may refer to the identity of a borrower as “borrower.”

According to various implementations of the invention, the hierarchical data structure may be used to ensure transaction information that is required for a particular transaction document is included in the transaction document. The hierarchical data structure may account for the transaction information that is required by facilitating validation of transaction information stored therein. In this manner, transaction information that is required for a particular transaction document may not be overlooked. On the other hand, transaction information that is irrelevant to the particular transaction document may be omitted from the transaction document.

For example, parties may efficiently exchange transaction information with one another because transaction information for the hierarchical data structure may be validated. In this manner, transaction information related to a transaction document received from a party that has different transaction information requirements may be efficiently exchanged even though the parties have different transaction information requirements. One party may rapidly identify missing transaction information from the hierarchical data structure that is required by that party but is not required by another party, for example.

In particular, a lending institution may use a mortgage application document that requires transaction information that describes a borrower's education level. If transaction information that describes the borrower's education level was not received, for example, transaction information for the mortgage application document may not be validated. In this manner, a loan officer for the lending institution that successfully generates a mortgage application document based on transaction information from the hierarchical data structure may be confident that transaction information requirements for the mortgage application have been met.

According to various implementations of the invention, parameters for validation of transaction information may be updated. In this manner, even if transaction information requirements for a transaction document are changed, validation may be updated in substantially real-time. Parties may create new transaction information requirements while using transaction information from the hierarchical data structure that was received before the new transaction information requirements.

According to various implementations of the invention, the hierarchical data structure may facilitate identification of transaction documents that are required for a particular transaction. For example, processing a mortgage loan may involve generating a mortgage application document as well as truth-in-lending disclosure documents. The hierarchical data structure may facilitate identification of these requirements and enable efficient processing of the mortgage.

In operation, parties may use the hierarchical data structure to efficiently exchange transaction information for diverse types of transactions. For example, a lending institution may be a party to a lending contract. The lending institution may use the hierarchical data structure to order transaction documents related to regulatory issues associated with the contract. A residential unit of the lending institution may use the hierarchical data structure to order mortgage application documents related to mortgage transactions. Likewise, a corporate lending unit of the lending institution may use the hierarchical data structure to order commercial lending documents related to commercial loans. Here, the deposit account, mortgage, and commercial loan may each have different transaction information requirements. According to various implementations of the invention, the same, single, hierarchical data structure nonetheless enables efficient storage and use of transaction information from these and other types of financial transactions.

Furthermore, parties may use the hierarchical data structure to efficiently exchange transaction information even though the transaction information is received from parties that store transaction information differently from one another. For example, a lending institution may wish to purchase a standard set of transaction documents for interfacing with a variety of other lending institutions that each have different transaction formats and/or content for the transaction documents. In this manner, the lending institution may avoid the time and expense of parsing each of the transaction documents from the other lending institutions.

Transaction information may be from a broad variety of types of transactions. Transaction information may also be differently stored depending on the party storing them. Nonetheless, the hierarchical data structure enables efficient storage and usage of the transaction information stored therein. The hierarchical data structure provides a single data schema for documenting transactions between a customer and a financial institution throughout a variety of localities, allowing single integration of transaction information regardless of local practices. The single integration allows for a financial institution or other party integrating to the data schema to originate consumer loans, commercial loans, portfolio mortgages, conforming mortgages, home equity loans, deposit accounts, retirement or other tax favored deposit accounts, and/or other transactions without the need for multiple, expensive and time-intensive integrations. For example, via the use of roles, data identifying parties to a transaction may be mapped to by the integrating party only once. Thereafter, the same data may be used within all areas of the financial institutions simply by applying different roles and uses to the same data and associating via ID references.

Other objects and advantages of the invention will be apparent to those skilled in the art based on the following drawings and detailed description.

### BRIEF DESCRIPTION OF THE DRAWINGS

FIG. 1 illustrates a block diagram of an exemplary system for representing various transactions according to various implementations of the invention.

FIG. 2 illustrates a block diagram of an exemplary computing device for representing various transactions according to various implementations of the invention.

FIG. 3 illustrates a block diagram of an exemplary hierarchical data structure categorizing transaction information according to various implementations of the invention.

FIG. 4 illustrates a block diagram of an exemplary category of transaction information within an exemplary hierarchical data structure representing transaction information according to various implementations of the invention.

FIG. 5 illustrates a flow diagram of an exemplary method for categorizing transaction information according to various implementations of the invention.

FIG. 6 illustrates a flow diagram of an exemplary method for representing various transactions according to various implementations of the invention.

### DETAILED DESCRIPTION

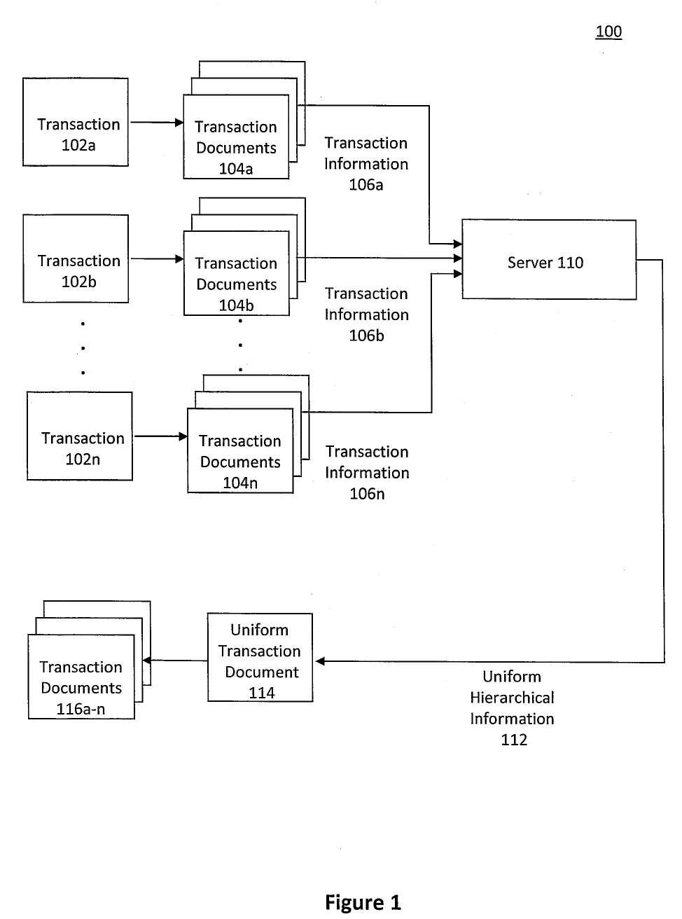

FIG. 1 illustrates an exemplary transaction information system 100 that may provide a framework for representing various transactions 102 (illustrated in FIG. 1 individually as a transaction 102a, a transaction 102b, and a transaction 102n) according to various implementations of the invention. Transactions 102 may be related to deposit accounts, retirement accounts, consumer lending, commercial lending, mortgage, and/or other types of transactions. Transactions 102 typically are documented with or “papered by” or otherwise depend upon, one or more transaction documents 104 (illustrated in FIG. 1 as transaction documents 104a, transaction documents 104b, and transaction documents 104n) according to various implementations of the invention. Transaction documents 104 may be any document related to process, complete, memorialize, or otherwise use for transactions 102. For example, transaction documents 104 may include a mortgage application, a deposit account document, a contract, disclosure documents, and/or other transaction documents 104 depending on the type of transaction 102 associated therewith. A mortgage application, for example, may have a different format than a deposit account document. Furthermore, depending upon the institution or industry, one transaction, such as transaction 102a that is the same type as another may have different transaction documents 104. For example, one mortgage application may have a different format than another mortgage application.

Transaction documents 104 may include corresponding transaction information 106 (illustrated in FIG. 1 as transaction information 106a, transaction information 106b, and transaction information 106n) according to various implementations of the invention. Transaction information 106 includes data that is related to transactions 102. As mentioned, this transaction information 106a for transaction documents 104a may be in the same or different formats from transaction information 106b for transaction documents 104b even though transaction information 106a and transaction information 106b are substantially the same. Furthermore, transaction information 106a from transaction document 104a may be referred to differently than transaction information 106b from transaction document 104b even though transaction information 106a and transaction information 106b are substantially the same.

For example, when a transaction 102 includes a mortgage transaction, transaction documents 104 may include a mortgage application. The mortgage application may refer to certain transaction information 106 such as a “Borrower” in reference to an individual seeking the mortgage. When a transaction 102 includes a deposit account, transaction documents 104 may include a deposit account document. The deposit account document may refer to certain transaction information 106 such as an “Account Owner” in reference to an individual owning the deposit account. In some cases, the individual may be the same person despite being referred to as “Borrower” with respect to the mortgage transaction and as “Account Owner” with respect to the deposit account transaction. Even though the two transactions likely share some content (e.g., an identity of the individual), the transaction information 106 may represent that content in a different format or use entirely different content between the two transactions.

According to various implementations of the invention, server 110 may receive transaction information 106. Server 110 may process the received transaction information 106 as discussed in further detail below. According to various implementations of the invention, server 110 may render uniform hierarchical information 112 based on the processed transaction information 106. Uniform hierarchical information 112 may be used to generate uniform transaction document 114.

According to various implementations of the invention, uniform transaction document 114 may use a format that is capable of representing uniform hierarchical information 112. Such a format may include, for example, Extensible Markup Language (XML), tab-delimited text, comma-separated value file, or other format suitable to represent the hierarchical data structure.

According to various implementations of the invention, uniform transaction document 114 may include some or all data necessary to complete, process, or otherwise use with transactions 102. As such, uniform transaction document 114 may be used generate or populate one or more transaction documents 116. Uniform transaction document 116a-n may represent, for example, a mortgage application transaction, and/or other type of transaction. In this manner, uniform transaction documents 116 may correspond to or include substantially the same content or format as transaction documents 104. In this manner, instead of representing various different transaction information 106 in various different transaction documents 104, which each may contain different content or format from one another, transaction information 106 may be represented by uniform transaction document 114, which may take into account the various differences among transaction documents 102.

It should be understood that server 110 may be any hardware or software-enabled hardware component suitable to carry out features and functions according to various implementations of the invention.

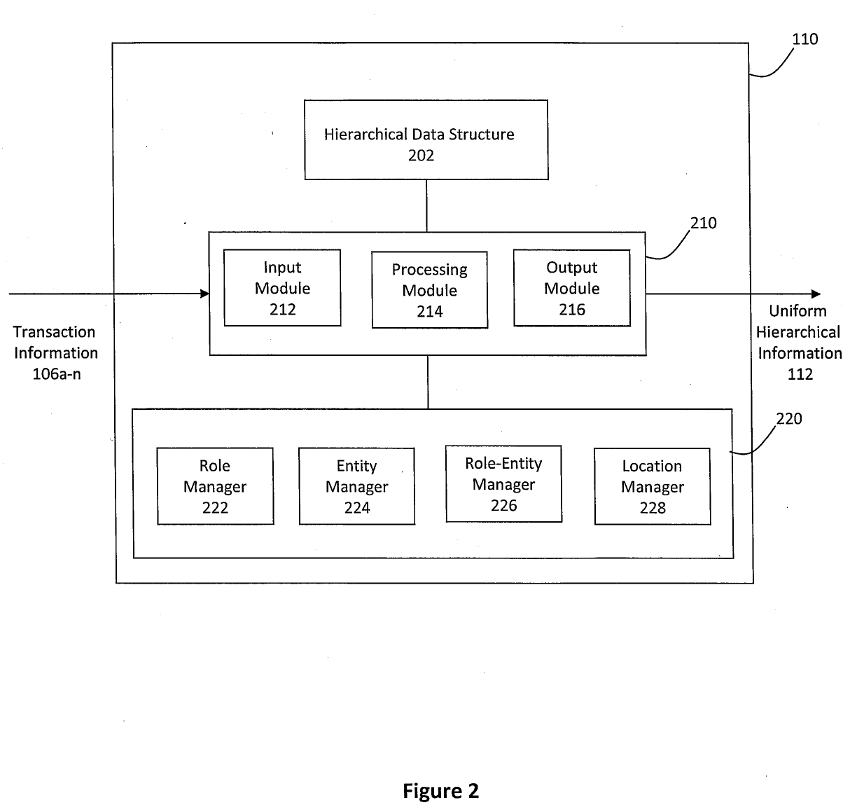

According to various implementations of the invention, as illustrated in FIG. 2, for example, server 110 may include an input module 212 for receiving transaction information 106. Transaction information 106 may be received or derived from a variety of sources of transaction documents 102.

As discussed above, transaction information 106a from transaction documents 102a may include different content or have content in different formats compared to transaction information 106b from other transaction documents 102b. According to various implementations of the invention, input module 212 may account for these and other differences using one or more translation modules (not otherwise illustrated). Alternatively or additionally, input module 212 may receive data that has already been translated. For example, the one or more translation modules may each be specific to a particular one of transactions 102 (e.g., transaction 102a) being processed. Thus, the one or more translation modules may function as adaptors that account for the various differences among different transaction information 106. On the other hand, input module 212 may receive data that has already been translated.

According to various implementations of the invention, once received, the data in received transaction information 106 may be processed. Processing module 214 may process the received transaction information 106. Processing may include rendering the transaction information 106 into a hierarchical data structure 202. It should be understood that processing module 214 may translate the received transaction information 106 as discussed above.

According to various implementations of the invention, an output module 216 may use hierarchical data structure 202 to render uniform hierarchical information 112. Uniform hierarchical information 112 may uniformly refer to data that is otherwise referred to differently among transaction information 106 from the plurality of transactions 102.

According to various implementations of the invention, processing transaction information 106 may include using various combinations of data depending upon the transaction information 106 being processed. Furthermore, standard vocabularies may be used to define, describe, or otherwise refer to various data in transaction information 106. As such, processing module 214 may be associated with a configuration module 220.

According to various implementations of the invention, configuration module 220 may comprise a role manager 222, an entity manager 224, a role-entity manager 226, a location manager 228, and/or other suitable modules. Configuration module 220 may use these or other modules to describe data configurations, define standard vocabularies, or otherwise assist processing module 214 to represent data from transaction information 106 into hierarchical data structure 202. Data configurations may include permissible data types, permissible data combinations, and/or other data configurations. As such, configuration module 220 may assist processing module 214 to render data from transaction information 106 into hierarchical data structure 202.

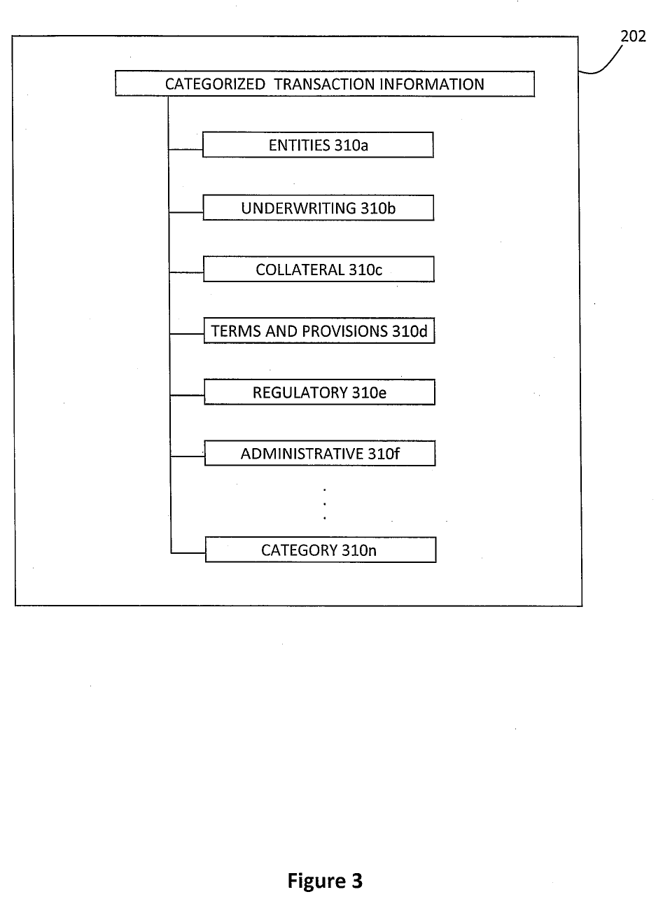

According to various implementations of the invention, as illustrated in FIG. 3, for example, hierarchical data structure 202 may categorize transaction information 106 into one or more categories such as, for example, categories 310a, 310b, 310c, 310d, 310e, 310f, and/or any other categories 310n. Categories 310 may define a top level of the hierarchical data structure 202. Categories 310 may include, for example, an Entities category 310a, an Underwriting category 310b, a Collateral category 310c, a Terms and Provisions category 310d, a Regulatory category 310e, an Administrative category 310f, and/or other categories 310n. For example, the Entities category 310a may describe parties related to a transaction. The Underwriting category 310b may describe criteria affecting the transaction, such as criteria affecting a decision to extend credit and/or other criteria. The Collateral category 310c may describe collateral that is related to the transaction. The Terms and Provisions category 310d may describe terms and provisions related to the transaction. The Regulatory category 310e may describe information related to the regulatory environment of the transaction. The regulatory environment may include, for example, federal, state, and/or local disclosure requirements. The Administrative category 310f may describe administrative rules related to the transaction. By categorizing transaction information 104 in this manner, a robust set of information related to transactions 102 may be represented in hierarchical data structure 202. For example, categories 310 may follow the natural manner in which professionals understand and organize transaction data. As such, emphasis is placed on data itself rather than the documents that accommodate that data.

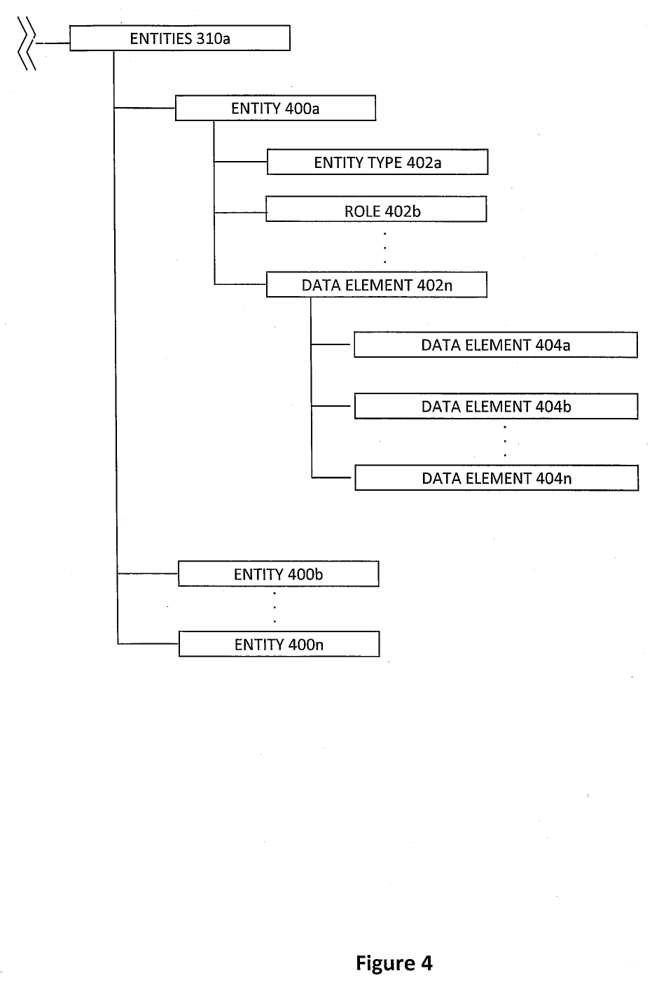

According to various implementations of the invention, as illustrated in FIG. 4, the hierarchical data structure 202 may include one or more data elements or data fields (discussed below). This structure reflects the plural-to-singular structure of hierarchical data structure 202. The data elements may describe data related to transactions 102 that may be categorized under a particular category. According to various implementations of the invention, each category may include one or more data elements. By having the ability to include more than one data element, each category 310 may include many types of similar data related to one another, enabling a robust representation of transaction information 106.

For example, according to various implementations of the invention, as illustrated in FIG. 4, Entities 310a may comprise one or more data elements 400a, 400b . . . 400n (data elements 400). Data elements 400 may describe data from transaction information 106 that may be categorized under the Entities 310a category, for example. Furthermore, each data element 400 may include other data elements 402a, 402b . . . 402n (data elements 402) that are nested within data element 400. Data elements 402, for example, may further describe data regarding data element 400. Still further, each data element 402, for example, may include one or more nested data elements 404a, 404b . . . 404n (“nested data elements 404”) that are nested within data element 402. Nesting of data elements may continue into further levels of nesting as would be apparent.

In particular, as illustrated, data element 400a may represent an entity (shown here as entity 400a). Entity 400a may describe a party related to the one or more transactions 102. A party may include, for example, a mortgage applicant, a loan officer, a government official, or any other party related to the one or more transactions 102. There may be many parties to a transaction 102. As such, entities 310a may include multiple data elements 400 representing each of the parties to the transaction 102. According to various implementations of the invention, each party among the parties may be uniquely identified and represented by a data element 400. Entities may be identified by name, numeric identifier, or any other identifier so long as the identifier is unique among the set of identifiers that each identify an entity. Furthermore, the entity identifier may be represented within the hierarchical data structure 202 (not otherwise illustrated).

Each party related to a transaction 106 may correspond to one or more different types of parties. For example, an “Individual” is a different type of party than a “Business” or “Corporation.” As such, according to various implementations of the invention, entity 400a, for example, may include a nested data element Entity Type 402a. An Entity Type 402a describes a type of entity such as, for example, “Individual,” “Corporation,” or other type of entity. Entity Type 402a may be predefined using a standard, normalized, vocabulary, such as the exemplary vocabulary listed in Table 1 herein. For example, a mortgage applicant may be defined as an “Individual” entity type while a business entity may be defined as a “Corporation” entity type.

According to various implementations of the invention, entity 400a may have different data requirements based on entity type 402a. In other words, an “Individual” may have information associated with the Individual that is different from information associated with a “Business.” For example, the Individual may be associated with information related to a spouse while the Business would not. Furthermore, entity 400a may have similar data that refers to different information. For example, an “address” of the Individual may refer to the home mailing address of the Individual. By contrast, for example, the “address” of the Business may be a place of incorporation. This reflects various different data combinations that may be represented by the hierarchical data structure 202. In particular, entity type 402a may drive or define other data elements within hierarchical data structure 202. Furthermore, a particular role (discussed below) may require a particular entity type 402a definition. Exemplary roles and their required entity types are listed in Table 1 below.

TABLE 1
Exemplary roles and entity types.

| Role | Entity Type |
|---|---|
| ResolvingParty | Sole Proprietorship |
| | General Partnership |
| | Limited Partnership |
| | Limited Liability Partnership |
| | Limited Liability Company |
| | Corporation or Professional Corporation |
| | Business Trust |
| | Association or Organization |
| | Governmental Entity |
| SigningBusinessEntity BorrowerAuthorizedSigner | Sole Proprietorship |
| GuarantorAuthorizedSigner | General Partnership |
| HypothecatorAuthorizedSigner NoticeOfLimitation | Limited Partnership |
| | Limited Liability Partnership |
| | Limited Liability Company |
| | Corporation |
| | Trust with Individual Trustee |
| | Trust with Non-Individual Trustee |
| Contractor | Individual |
| ContractOtherParty | Sole Proprietorship |
| ReportingAgency | General Partnership |
| Landlord | Limited Partnership |
| FarmProductPotentialBuyer NoticeOfLimitationExecutingParty | Limited Liability Partnership |
| Mortgagor | Limited Liability Company |
| AttorneyInFact | Corporation |
| AccountOwner | Trust |
| Borrower | Association |
| Guarantor | Governmental Entity |
| Hypothecator | |
| LifeInsuranceBeneficiary | |
| Architect | |
| ElectronicDisclosureAuthorizedSigner FiduciaryAppointee | Individual |
| | Non-Individual |
| Trustee | Corporation |
| | Partnership |
| | Limited Liability Company |
| | Sole Proprietorship |
| | Limited Liability Partnership |
| | Association (Trust Authorization Use Only) |
| | Governmental Entity (Trust Authorization Use Only) |
| MortgageBroker | Sole Proprietorship |
| | General Partnership |
| | Limited Partnership |
| | Limited Liability Partnership |
| | Limited Liability Company |
| | Corporation |
| LifeInsuranceTrusteeBeneficiary LandlordTrustee | Individual |
| | Non-Individual |
| RealEstateNotary | One Notary for All Signers |
| | One Notary For Each Signer |
| RealEstateSubordinator Subordinator | Individual |
| | non-individual |

According to various implementations of the invention, entity manager 224 may define, describe, validate, or otherwise permit processing of entity types 400a and the various data combinations resulting from different entity types 400a. Processing module 214 may associate with entity manager 224 in order to manage an entity type 402a of entity 400a.

Each party related to a transaction 106 may play different roles. For example, an entity 400a applying for a loan may play a “Borrower” role while an entity 400a that approves a loan may play a “LendingInstitution” role. Other roles are contemplated. As such, according to various implementations of the invention, entity 400a, for example, may include a nested data element illustrated as role 402b. Role 402b may be predefined using a standard, normalized, vocabulary, such as the exemplary vocabulary listed in Table 2 herein.

TABLE 2
Exemplary Entity Roles

| | |
|---|---|
| AccountChangeRequestingParty | AccountOwner |
| AccountOwnerAuthorizedSigner | AccountOwnerBeneficiary |
| AccountOwnerCustomerContact | AccountOwnerEmployer |
| AffiliatedBusinessArrangementEntity | AlternateCreditor |
| ApplicantOnStatementOfCreditDenial | Appraiser |
| Architect | ArchitectAcknowledgeeBusiness |
| ArchitectAcknowledgeeIndividual | ArchitectAttestingParty |
| ArchitectAuthorizedSigner | ArchitectOwner |
| AssignmentOfLeasesAndRentsRecordingAgency | ATMApplicant |
| ATMApplicantEmployer | AttestingParty |
| AttorneyInFact | AttorneyInFactAttestingParty |
| AttorneyInFactAttestingParty2 | AttorneyInFactAuthorizedSigner |
| AttorneyInFactSpouse | AttorneyInFactSuccessor |
| AuthorizedSigner | AuthorizedSignerBorrower |
| Beneficiary | BeneficiaryDeceased |
| BeneficiaryRepresentative | BondBeneficiary |
| BondBeneficiaryCoOwner | BondCoOwner |
| BondPurchaser | BondRecipient |
| Borrower | BorrowerAuthorizedSigner |
| BorrowerCertificationSigner | BorrowerExecutiveOfficer |
| BorrowerMilitary | BorrowerSpouse |
| BorrowerTrusteeCertificationSigner | BroadResolutionSigner |
| Build | Builder |
| BusinessAcknowledgees | CashDepositHolder |
| CertifyingPartyAuthorizedSigner | CertifyingTINAttestor |
| ClaimingBeneficiary | ClaimingBeneficiaryAuthorizedSigner |
| CollateralCoOwner | CollateralCoOwnerCertificationSigner |
| CollateralCoOwnerSpouse | CollateralInsurer |
| CollateralOwner | CollateralOwnerIndividualAcknowledgee |
| CommercialAuthorizedSigner | CommercialLoanIndividual |
| ConsentingElectronicSigner | ConsolidationExtensionModificationMortgagor |
| ConsumerRealEstateSecurityInstrumentMortgagor | ConsumerReportingAgency |
| Contractor | ContractorAttestingParty |
| ContractorAuthorizedSigner | ContractorBusinessAcknowledgee |
| ContractorIndividualAcknowledgee | ContractorOwner |
| ContractOtherParty | Cosigner |
| CosignerSpouse | CreditDisabilityInsurance |
| CreditDiscountApplicant | CreditInsuranceRequestSigner |
| CreditLifeInsurance | CreditLifeInsuranceDebtProtection |
| Creditor | CurrentServicer |
| Custodian | DairyProductPurchaser |
| DairyProductPurchaserAuthorizedSigner | DairyProductPurchaserWitness |
| DairyProductPurchaserWitness2 | DeedOfTrustTrustee |
| Depositor | DepositServicingDocumentSigner |
| DepositTrustee | DocumentPreparer |
| EFTPostingMerchant | ElectronicDisclosureAuthorizedSigner |
| ElectronicDisclosureCustomer | ElectronicSignatureConsentingParty |
| ElectronicSignatureConsentingPartySigner | Employer |
| ESADepositor | ESADesignatedBeneficiary |
| ESAResponsibleIndividual | ESAResponsibleIndividualEmployer |
| EscrowHolder | ExistingMortgagee |
| ExpectedEncumbranceBeneficiary | FacsimileSigner |
| FarmProductPotentialBuyer | FarmProductPotentialBuyerContact |
| FederalAgency | FederalPaymentReceivingParty |
| FHALender | FiduciaryAppointee |
| FiduciaryWard | FinancialInstitution |
| FinancialInstitutionAdverseActionContact | FinancialInstitutionATMContact |
| FinancialInstitutionATMDispute | FinancialInstitutionATMDisputeContact |
| FinancialInstitutionATMSafetyContact | FinancialInstitutionATMSecurity |
| FinancialInstitutionAuthorizedBackupWitholdingRepresentative | FinancialInstitutionAuthorizedSigner |
| FinancialInstitutionAuthorizedSigner2 | FinancialInstitutionBiennialRenewalSigner |
| FinancialInstitutionBranch | FinancialInstitutionCDCounterSigner |
| FinancialInstitutionConstructionLoanOriginator | FinancialInstitutionContact |
| FinancialInstitutionCreditDenialSender | FinancialInstitutionDistributing |
| FinancialInstitutionEFTInvestigationContact | FinancialInstitutionEFTOriginator |
| FinancialInstitutionEFTRepresentative | FinancialInstitutionEFTTransactionBalancingBranch |
| FinancialInstitutionElectronicDisclosureContact | FinancialInstitutionfHELOC |
| FinancialInstitutionIntermediary | FinancialInstitutionIssuing |
| FinancialInstitutionLending | FinancialInstitutionLendingDecisionOfficer |
| FinancialInstitutionMortgageDisclosureProvider | FinancialInstitutionOriginatorOrReceiving |
| FinancialInstitutionParticipationPurchasing | FinancialInstitutionParticipationPurchasingSigner |
| FinancialInstitutionPreauthorizedPayment | FinancialInstitutionPreparer |
| FinancialInstitutionPriorTransaction | FinancialInstitutionPurchasing |
| FinancialInstitutionReceiving | FinancialInstitutionRepresentativeApprovingBackupWithHolding |
| FinancialInstitutionRepresentativeATMApplication | FinancialInstitutionServicingTransfer |
| FinancialInstitutionStopPaymentReceiving | FinancialInstitutionSubstituteCheck |
| FinancialInstitutionTransactionBranch | FinancialInstitutionTransactionInstitution |
| FinancialInstitutionTransferServicingContact | FinancialInstitutionVerifyingRepersentative |
| FirstLienPrivateInvestor | FundingInstitution |
| FundsTransferBeneficiary | FundsTransferConfirmer |
| FundsTransferParty | FundsTransferVerifierSigner |
| GapInsuranceSigner | GuaranteeIndividualAcknowledgee |
| Guarantor | GuarantorAttestingParty |
| GuarantorAttorneyInfact | GuarantorAuthorizedSigner |
| GuarantorBusinessAcknowledgee | GuarantorCertificationSigner |
| GuarantorIndividualAcknowledgee | GuarantorSpouse |
| GuarantorTrusteeAuthorizedSigner | GuarantorTrusteeCertificationSigner |
| GuardianDelegate | HazardInsuranceParty |
| HELOCThirdPartyFeePaidParty | HomeEquityConversionMortgageCounselingAgency |
| HSAAccountAuthorizedSigner | HSAAccountOwner |
| HUDSecretary | HUDVeteranAffairsSponsor |
| Hypothecator | HypothecatorAttestingParty |
| HypothecatorAuthorizedSigner | HypothecatorBusinessAcknowledgee |
| HypothecatorCertificationSigner | HypothecatorIndividualAcknowledgee |
| HypothecatorSpouse | HypothecatorTrusteeAuthorizedSigner |
| HypothecatorTrusteeCertificationSigner | IndependantCertifier |
| IndirectLendingDealer | IndirectLendingDealerAuthorizedSigner |
| IndividualAcknowledgee | IndividualGuarantor |
| IndividualHypothecator | IndividualSubordinator |
| InstallmentContractAssignee | InsuranceAgent |
| InsuranceAgentAntiCoercion | InsuranceAnnuityCompany |
| InsuranceBeneficiaryAttestingParty | InsuranceBeneficiaryAuthorizedSigner |
| InsuranceBeneficiaryBusinessAcknowledgee | InsuranceBeneficiaryIndividualAcknowledgee |
| InsuranceCompany | InsurancePolicyBeneficiary |
| InsurorAnnuityGrantor | InterestedParty |
| Interviewer | IRSRequestor |
| IRSTaxpayer | IRSTaxpayerSigner |
| IRSTaxpayerSpouse | IRSThirdParty |
| JuniorLienHolder | JuniorLienHolderAuthorizedSigner |
| JuniorLienHolderSignerAcknowledgee | LandContractPurchaser |
| LandContractSeller | Landlord |
| LandlordAttestingParty | LandlordAuthorizedSigner |
| LandlordBusinessAcknowledgee | LandlordIndividuaiAcknowledgee |
| LandlordSpouse | LandlordTrustee |
| LandTrustTrustee | LandTrustTrusteeSigner |
| LenderAcknowledgee | LenderOfficer |
| LenderToBePaidOff | LendingFinancialInstitutionAuthorizedSigner |
| LetterOfCreditAdvisingBank | LetterOfCreditApplication |
| LetterOfCreditBeneficiary | LetterOfCreditCargoCompany |
| LetterOfCreditConfirmingBank | LetterOfCreditEdibleGoodsCertifyingParty |
| LetterOfCreditHealthSanitationCertifyingParty | LetterOfCreditMultimodalTransportDocumentIssuer |
| LetterOfCreditOriginator | LetterOfCreditQualityCertifyingEntity |
| LetterOfCreditReceiver | LetterOfCreditWeightOrGoodsCertifyingEntity |
| LienNoticeDesignatedRecipient | LifeInsuranceAgent |
| LifeInsuranceBeneficiary | LifeInsuranceBeneficiaryAttestor |
| LifeInsuranceCompany | LifeInsuranceCompanyRepresentative |
| LifeInsuranceInsuredParty | LifeInsuranceSoleProprietorBeneficiary |
| LifeInsuranceTrusteeBeneficiary | LoanAgreementGuarantor |
| LoanDisbursementReceipient | LoanDisbursementRecipient |
| LoanOfficer | LoanQuotePreparer |
| LoanServicer | LockingGuaranteeLender |
| ManufacturedHomeMaker | MoneyServicesBusiness |
| MortgageAssignee | MortgageBroker |
| MortgageBrokerAffiliatedCompany | MortgageBrokerLoanOfficer |
| MortgageBrokerParentCompany | MortgageBrokerPrimaryLender |
| MortgageBrokerPrimaryLender2 | MortgageBrokerPrimaryLender3 |
| MortgageBrokerRepresentative | Mortgagee |
| MortgageInsuranceParty | MortgageLender |
| MortgageLoanOriginationBroker | MortgageNotary |
| Mortgagor | MortgagorNonOwnerSpouse |
| MortgagorSpouse | MortgagorSpouse2 |
| NavajoDebtCounsleor | NavajoOtherEntityIndividual |
| NewServicer | NightBagAgent |
| NonAccountOwnerSpouse | NonBorrowerSpouse |
| NonOwnerSpouseCertificationSigner | NonOwnerTaxFavoredAccountDistributionRequestor |
| NonPropertyOwnerTitleHoider | Notary |
| NoticeOfLimitation | NoticeOfLimitationAttestor |
| NoticeOfLimitationAuthorizedSigner | NoticeOfLimitationBusinessAcknowledgee |
| NoticeOfLimitationExecutingParty | NoticeOfLimitationIndividual |
| NoticeOfLimitationIndividualAcknowledgee | NoticeOfLimitationSoleProprietor |
| NoticeOfLimitationSpouse | NoticeOfLimitationTrustee |
| OriginalMortgagee | OriginationCertificateIssuingAgency |
| OtherCourier | OutsideInformationSource |
| PartnerAssignor | Partnership |
| PartyToRecieveDocumentsOnBehalfOfRealPropertyOwner | PowerOfAttorneyPrincipal |
| PowerOfAttorneySuccessor | PreAuthorizedPaymentOriginator |
| PresentLienHolder | PreviousEmployer |
| PrimaryVehicleCreditor | PrincipalWitness |
| PrincipalWitness2 | PublicTrustee |
| QualifledWrittenRequestContact | QualityCertifier |
| QuestionsAgency | RealEstateAgent |
| RealEstateAssignee | RealEstateNotary |
| RealEstateSecurityAgreementAcknowledgee | RealEstateSecurityAgreementPurchaser |
| RealEstateSecurityInstrumentPurchaseParty | RealEstateSecurityInstrumentSignerAuthorizedSigner |
| RealEstateSubordinationAuthorizedSigner | RealEstateSubordinator |
| RealPropertywitness | RealPropertyWitness2 |
| ReceivingParty | RecordableInstrumentPreparer |
| RecordableInstrumentReturnToParty | RecordingAgency |
| RemainingEncumbranceBeneficiary | RemainingLienHolder |
| RemovedAuthorizedSigner | RemovedSafeDepositDeputy |
| RemovedTrustee | RemovedUTMASuccessorCustodian |
| ReportingAgency | RepresentativeFeePayableTo |
| ResolutionAttestingParty | ResolvedBusiness |
| ResolvingParty | ResolvingPartyAttestor |
| ResolvingPartyAuthorizedSigner | ResolvingPartyRepresentative |
| SafeDepositBoxDeputy | SafeDepositBoxLegalRepresentative |
| SafeDepositBoxRenter | SafeDepositBoxRenterAppointingALegalRepresentative |
| SafeKeepingRepresentative | SecurityInstrumentAssignee |
| Seller | SellerAssistedLoanProvider |
| SellerRepresentative | SellingAgent |
| SeniorLienHolder | ServiceContractCompany |
| SettlementAgent | SettlementProvider |
| SigningBusinessEntity | SoleProprietorAccountOwner |
| SoleProprietorArchitect | SoleProprietorAttorneyInEact |
| SoleProprietorBorrower | SoleProprietorContractor |
| SoleProprietorContractOtherParty | SoleProprietorFarmProductPotentialBuyer |
| SoleProprietorGuarantor | SoleProprietorHypothecator |
| SoleProprietorLandlord | SoleProprietorResolvingParty |
| StateRegulatingAgency | StockIssuer |
| StopPaymentOrderSigner | SubObligor |
| Subordinator | SubordinatorSigner |
| SubordinatorWitness | SubordinatorWitness2 |
| TaxFavoredAccountAuthorizedSigner | TaxFavoredAccountBeneficiary |
| TaxFavoredAccountNonAccountOwnerDistributionRequestor | TaxFavoredAccountOwner |
| TaxFavoredAccountWitness | TaxpayerSpouse |
| ThirdPartyFeePayee | ThirdPartyOriginator |
| TransferAgreementAuthorizedOriginator | Trust |
| TrustAccountOwner | TrustBeneficiary |
| TrustCreator | Trustee |
| TrusteeAttestor | TrusteeAttorneyInFact |
| TrusteeDeedOfTrustNoticeOfSaleOrDefault | TrusteeDischargeOfDeedOfTrust |
| TrusteeLandlord | TrusteeResolvingParty |
| TrustMortgagor | UCCRecordingAgency |
| Underwriter | UTMACustodian |
| UTMACustodianEmployer | UTMACustodianWitness |
| UTMADesignationWitness | UTMAMinor |
| UTMAMinorEmployer | UTMASuccessor |
| UTMATransferor | UTMATransferorWitness |
| VehicleBroker | VehicleContractOtherPayableParty |
| VehicleDealer | VeteranAffairsAuthorizedAgent |
| Warrantor | WireTransferConfirmingParty |
| Witness | Witness2 |

According to various implementations of the invention, entity 400a may have different data requirements based on role 402b. In other words, a “Borrower” may have information associated with the Borrower that is different from information associated with a “LendingInstitution.” For example, the Borrower may be associated with information related to personal income while the Business would not. This reflects various different data combinations that may be represented by the hierarchical data structure 202. In particular, role 402b may drive or define other data elements within hierarchical data structure 202.

According to various implementations of the invention, a data element 400 may be used to reduce the redundancy of transaction information 106 for a transaction 102. The result is a many-fold reduction in the number of data points that is mapped to by users of the hierarchical data structure 202 and a concomitant reduction in the number of data that is to be entered by a party when processing and/or executing a transaction. For example, data entered by a financial institution may be minimized when processing a transaction such as originating a new loan, opening a new account, and/or other transaction.

According to various implementations of the invention, role 402b may be used, inter alia, to reduce the number of data points that is mapped to by users of the hierarchical data structure. A transaction may require certain data related to the parties to the transaction to be captured and processed. Such data often includes, for example, an identity of a party, street address, city address, state address, zip code, various phone numbers, and/or other data. Furthermore, each party may serve various roles in the transaction. For example, a party may be the applicant, who is also the borrower, who, in turn, is also the mortgagor. According to various implementations of the invention, instead of redundantly storing/capturing information related to the applicant, borrower, and mortgagor, this information is captured once by using roles. The role data element 402b, for example, may reduce the transaction information associated with the entity data element 400a. In this example, the applicant, borrower, and mortgagor are assigned an entity ID. The role data element 402b is not limited to the entity data element 400a. Various collateral (not otherwise shown), for example, may serve one or more roles within a credit transaction. Other data elements may similarly be used to streamline the hierarchical data structure.

According to various implementations of the invention, role manager 222 may define, describe, or otherwise permit processing of roles 402b and the various data combinations resulting from different roles 402b. Processing module 214 may associate with role manager 222 in order to manage an roles 402b of entity 400a.

According to various implementations of the invention, certain combinations of entity types 402a and roles 402b may be restricted. For example, an entity 400a described by entity type 402a of “Individual” may not be described by a role 402b of “FinancialInstitutionBranch” because an individual would not be described as having this role 402b. Furthermore, according to various implementations of the invention, certain combinations of entity types 402a and roles 402b may be permissibly allowed. Alternatively or additionally, certain combinations of entity types 402a and roles 402b may be mandatory when certain entity types 402a and roles 402b are used.

According to various implementations of the invention, Role-Entity manager 226 may define, describe, validate, or otherwise permit processing of these and other combinations of entity types 402a and roles 402b. Processor module 314 may associate with Role-entity manager 226 in order to define various restricted, permissibly allowed, mandatory, or other combinations of entity types 402a and roles 402b.

As described above, entity type 402a and/or role 402b may further drive, for example, other data elements. For example, a location use code 402c may be affected by entity type 402a and/or role 402b. Location use code 402c may be a data element that is nested within entity 400a, for example. Location use code 402c may be used to describe location information of an entity. Location information may describe geographic, electronic (such as website, email, etc.), or other location information of an entity 400a. Location use code 402c may describe the type or purpose of location information that is described. For example, location use code 402c “Account” may describe an address of a deposit account while location use code 402c “Birth” may describe a country of birth for an entity 400a. In this manner, location use code 402c may be used to represent a variety of information related to locations.

According to various implementations of the invention, location use code 402c may be based or depend upon other data elements such as entity type 402a, role 402b, or any other data element. For example, a location use code 402c of “Primary” may be different depending upon the entity type 402a of an entity 400a. In particular, location use code 402c of “Primary” for an entity 400a of entity type 402b “Individual” may indicate location information that relates to a primary mailing address for the Individual. By contrast, location use code 402c of “Primary” for an entity 400a of entity type 402b “Business” may indicate location information that relates to a place of business for the Business. Use of location use code may vary depending on the entity associated with the location use code.

Furthermore, depending on role 402b, certain location use codes 402c may be used. For example, location use code 402c “PreviousEmployer” may be used for entity role 402b of “Borrower.” Other types of location use code 402c are contemplated. For example, location use code 402c may be predefined using a standard, normalized, vocabulary, such as the exemplary vocabulary listed in Table 3 herein.

TABLE 3
Exemplary Location Use Codes and Brief Descriptions.

| | |
|---|---|
| Account | Address of the Deposit Account, if different from that of the |
| | account holder. |
| AlternateAccount | Address of the Account, if different from that of the account |
| | owner. |
| Birth | Country of the depositor's or signer's birth. |
| BondMailing | Address where bonds are to be mailed. |
| Branch | Branch Office location of the Originator's Financial Institution. |
| BusinessRegistered | Address at which the Role is organized, formed or registered; or |
| | where the governmental entity is based. |
| Destination | Address where the goods are being shipped to under the Letter |
| | of Credit. |
| ExistingHUDRealEstate | Address where the Borrower's real estate is located, on which |
| | there is a HUD/FHA-insured mortgage. |
| Filing | State in which the trust was created or state in which the |
| | Account Holder has filed its organizational establishment |
| | request. |
| Litigation | County where the litigation process takes place. |
| Mailing | Mailing address of the entity Role, if different from permanent |
| | residence. |
| NotaryVenue | Address at which the notarization is being sworn. |
| Origin | Address where the goods being shipped to a buyer are |
| | manufactured or from which they originate. |
| PowerOfAttorneyGrantingVenue | Address where the power of attorney was granted or created. |
| Previous | Address of the taxpayer, as shown on the taxpayer's last tax |
| | return filed, if different from the current address. |
| PreviousEmployer | Address of the Borrower's previous employer. |
| PreviousEmployer and (Country!=) | Address of the Borrower's previous employer, if outside of USA, |
| | Canada, or Mexico. |
| PreviousEmployer and (Country = Mexico) | State or zone in Mexico where the Borrower's previous |
| | employer is located. |
| PreviousResidence | Borrower's most recent previous address. |
| Primary | Primary address of the entity Role. |
| Registered | State in which the non-individual Party executing the Notice of |
| | Limitation is organized, formed, or registered. |
| Residence | State in which the entity Role is a resident. |
| Venue | Address at which the acknowledgment will be performed. |

Location use code manager 228 may validate, manage, or otherwise deal with these and other combinations for location use code 402c, as well as various types of location use codes 402c. According to various implementations of the invention, processing module 214 may associate with location use code manager 228 in order to process these and other inter-relationships.

Using the hierarchy of transaction information may allow for a robust representation of the plurality of transactions 102 and disparate data that may be associated therewith.

The following exemplary portions of hierarchical data structure 202 are illustrated below using XML code merely for convenience without being limiting.

Multiple entities: Individual Borrower, Non-Borrowing Spouse, Loan Officer Example

```
<Entities>
  <Entity id=“Borrower1”>
    <Roles>
      <Role>Borrower</Role>
    </Roles>
    <Individual>
      <MaritalStatus>1</MaritalStatus> <!-- Married -->
      <Date>
        <Birth>12/31/1901</Birth>
      </Date>
    </Individual>
    <EntityType>1</EntityType> <!-- Individual -->
    <Name>
      <Salutation>
        <Type>1</Type> <!-- Mr. -->
      </Salutation>
      <First>John</First>
      <Middle>Q.</Middle>
      <Last>Adams</Last>
      <Suffix>III</Suffix>
    </Name>
    <Phone>
      <Home>616-555-0123</Home>
      <Business>616-555-6789</Business>
      <BusinessExtension>246</BusinessExtension>
      <Fax>616-555-3456</Fax>
    </Phone>
    <Email>
      <Personal>jqadams@yahoo.com</Personal>
    </Email>
    <Locations>
      <Location Use=“Primary”>
        <PrimaryAddressLine>123 Main St.</PrimaryAddressLine>
        <City>Scranton</City>
        <StateOrProvince>PA</StateOrProvince>
        <PostalCode>44444</PostalCode>
      </Location>
    </Locations>
    <TIN>
      <SSN>
        <FullNumber>111-22-3333</FullNumber>
      </SSN>
    </TIN>
  </Entity>
  <Entity id=“JaneAdams”>
    <Roles>
      <Role>NonBorrowerSpouse</Role>
    </Roles>
    <Name>
      <First>Jane</First>
      <Middle>E.</Middle>
      <Last>Adams</Last>
    </Name>
    <TIN>
      <SSN>
        <FullNumber>123-45-6789</FullNumber>
      </SSN>
    </TIN>
  </Entity>
  <Entity id=“loanofficer”>
    <Name>
      <First>John</First>
      <Middle>Q.</Middle>
      <Last>Smith</Last>
    </Name>
    <Roles>
      <Role>LoanOfficer</Role>
    </Roles>
    <Business>
      <Number>
        <License>1234</License>
      </Number>
    </Business>
    <Signer>
      <DigitalSignatureImage><![CDATA[<file
type=“image”>\\Server1\DigSigs\
JohnSmithSig.bmp</file>]]</DigitalSignatureImage>
  </Signer>
  <Phone>
    <Business>212-555-1234</Business>
  </Phone>
  <Locations>
      <Location Use=“Primary”>
        <PrimaryAddressLine>1001 Bank St.</PrimaryAddressLine>
        <SecondaryAddressLine>Suite 706</SecondaryAddressLine>
        <City>Chicago</City>
        <ProvinceOrState>IL</ProvinceOrState>
        <PostalCode>54321</PostalCode>
      </Location>
    </Locations>
  </Entity>
</Entities>
```

IRA Transaction Example

```
<Entities>
    <Entity id=“JohnDoe”>
        <Roles>
            <Role>AccountOwner</Role>
        </Roles>
        <EntityType>1</EntityType> <!-- Individual -->
        <Name>
            <First>John</First>
            <Last>Doe</Last>
        </Name>
        <Locations>
            <Location Use=“Residence”>
                <PrimaryAddressLine>101 Happy Valley
Dr.</PrimaryAddressLine>
                <City>Portland</City>
                <StateOrProvince>ME</StateOrProvince>
                <PostalCode>10101</PostalCode>
            </Location>
        </Locations>
        <TIN>
            <SSN>
                <FullNumber>987-65-4321</FullNumber>
            </SSN>
        </TIN>
    </Entity>
    <Entity id=“JaneDoe”>
        <Roles>
            <Role>Beneficiary</Role>
        </Roles>
            <Name>
                <First>Jane</First>
                <Last>Doe</Last>
            </Name>
        <TIN>
            <SSN>
                <FullNumber>123-45-6789</FullNumber>
            </SSN>
        </TIN>
    </Entity>
</Entities>
```

Corporate Borrower with Hypothecation Example

```
<Entities>
    <Entity id=“AbcInc”>
        <Roles>
            <Role>Borrower</Role>
        </Roles>
        <Name>
            <Business>ABC Inc.</Business>
        </Name>
        <EntityType>7</EntityType> <!-- Corporation -->
        <Business>
            <Resolution>
                <Date>
                    <Document>1/1/2007</Document>
                </Date>
            </Resolution>
        </Business>
        <Locations>
            <Location Use=“Primary”>
                <PrimaryAddressLine>123 Industrial
                Ave.</PrimaryAddressLine>
                <City>Toledo</City>
                <StateOrProvince>OH</StateOrProvince>
                <PostalCode>55555</PostalCode>
            </Location>
        </Locations>
        <TIN>
            <TaxIDNumber>11-2222222</TaxIDNumber>
        </TIN>
        <SigningEntities>
            <SigningEntity>JohnDoe</SigningEntity>
            <SigningEntity>RichardRoe</SigningEntity>
        </SigningEntities>
    </Entity>
    <Entity id=“JohnDoe”>
        <Roles>
            <Role>AuthorizedSigner</Role>
            <Role>Hypothecator</Role>
        </Roles>
        <Name>
            <First>John</First>
            <Last>Doe</Last>
        </Name>
        <Individual>
            <Title>
                <Job>President</Job>
            </Title>
        </Individual>
        <Phone>
            <Business>616-555-6789</Business>
            <BusinessExtension>101</BusinessExtension>
            <Fax>616-555-3456</Fax>
        </Phone>
        <Email>
            <Business>jdoe@abc.com</Business>
        </Email>
        <Signer>
            <DigitalSignatureImage><![CDATA[<file
type=“image”>\\Server1\DigSigs\
JohnDoeSig.bmp</file>]]</DigitalSignatureImage>
        </Signer>
    </Entity>
    <Entity id=“RichardRoe”>
        <Roles>
            <Role>AuthorizedSigner</Role>
        </Roles>
        <Name>
            <First>Richard</First>
            <Last>Roe</Last>
        </Name>
        <Individual>
            <Title>
                <Job>Vice-President</Job>
            </Title>
        </Individual>
        <Phone>
            <Business>616-555-6788</Business>
            <BusinessExtension>102</BusinessExtension>
            <Fax>616-555-3456</Fax>
        </Phone>
        <Email>
            <Business>rroe@abc.com</Business>
        </Email>
        <Signer>
        <DigitalSignatureImage><![CDATA[<file
type=“image”>\\Server1\DigSigs\
RichardRoeSig.bmp</file>]]</DigitalSignatureImage>
    </Signer>
    </Entity>
</Entities>
```

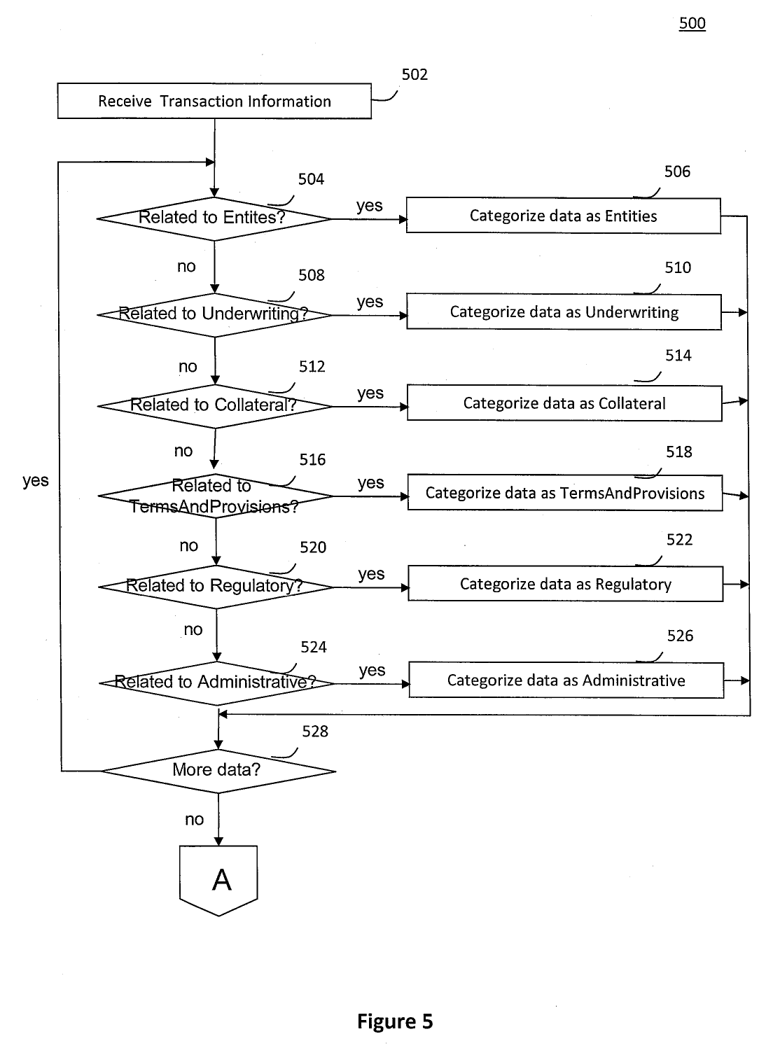

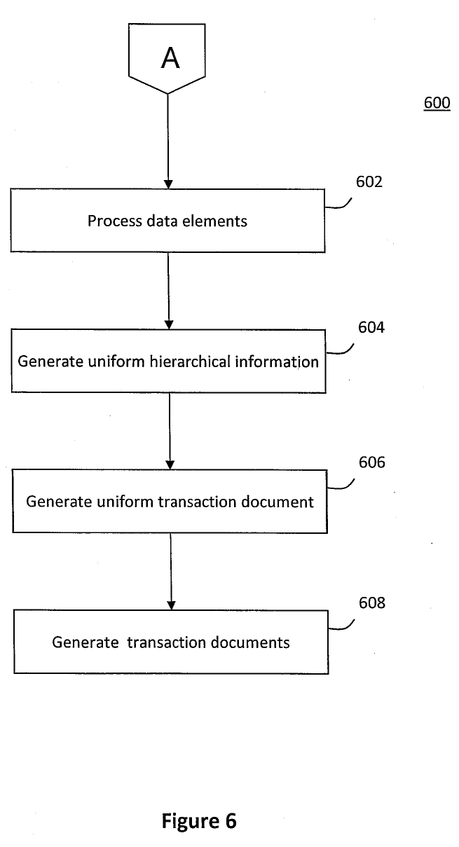

According to various implementations of the invention, FIG. 5 illustrates a flow diagram of an exemplary process 500 for categorizing transaction information 106. Process 500 may begin in an operation 502, where transaction information 106 is received. Different transactions may use different terms in the transaction information 106. As such, the received transaction information may have been translated into a standard format. Alternatively or additionally, the received transaction information may be translated after receipt. At any rate, once transaction information 106 is received, processing may proceed to an operation 504, wherein whether the data is related to entities 310a is determined. If in operation 504, the data is related to entities 310a, then processing may proceed to an operation 506, wherein the data is categorized as entities 310a. Processing may then proceed to an operation 528, wherein if more data is present, processing may return to an operation 504 for the additional data. If in operation 528, no more data is present, processing may proceed to “A,” as discussed with respect to FIG. 6, for example.

Returning to operation 504, if data is not related to entities 310a, processing may proceed to an operation 508, wherein whether the data is related to underwriting 310b is determined. If in operation 508, the data is related to underwriting 310b, then processing may proceed to an operation 510, wherein the data is categorized as underwriting 310b. Processing may then proceed to an operation 528 as before.

Returning to operation 504, if data is not related to underwriting 310b, processing may proceed to an operation 512, wherein whether the data is related to collateral 310c is determined. If in operation 512, the data is related to collateral 310c, then processing may proceed to an operation 514, wherein the data is categorized as collateral 310c. Processing may then proceed to an operation 528 as before.

Returning to operation 504, if data is not related to collateral 310c, processing may proceed to an operation 516, wherein whether the data is related to TermsAndProvisions 310d is determined. If in operation 516, the data is related to TermsAndProvisions 310d, then processing may proceed to an operation 518, wherein the data is categorized as TermsAndProvisions 310d. Processing may then proceed to an operation 528 as before.

Returning to operation 504, if data is not related to TermsAndProvisions 310d, processing may proceed to an operation 520, wherein whether the data is related to regulatory 310e is determined. If in operation 516, the data is related to regulatory 310e, then processing may proceed to an operation 522, wherein the data is categorized as regulatory 310e. Processing may then proceed to an operation 528 as before.

Returning to operation 504, if data is not related to regulatory 310e, processing may proceed to an operation 524, wherein whether the data is related to administrative 310f is determined. If in operation 524, the data is related to administrative 310f, then processing may proceed to an operation 526, wherein the data is categorized as administrative 310f. Processing may then proceed to an operation 528 as before.

According to various implementations of the invention, FIG. 6 illustrates a flow diagram of an exemplary process 600 for representing transaction information 106 that has been categorized according to various implementations of the invention. Each category may comprise one or more data elements. For example, the Entities category may include an entity data element that describes a party to a transaction being processed. The entity data element may itself comprise one or more nested data elements.

Process 600 may begin in an operation 602, wherein various data elements 400a-n, 402a-n, and 404a-n, among others, are processed and rendered into hierarchical data structure 202. For example, the one or more nested data elements may comprise a role data element. The role data element may describe the role played by the entity in the transaction. For example, a mortgage applicant may have a role of “Borrower.” Furthermore, the one or more second data elements may comprise an Entity Type data element. The Entity Type data element may describe the type of entity for an entity in the transaction. For example the mortgage applicant may have an Entity Type of “Individual,” indicating that the mortgage applicant is an Individual as opposed to a “Corporation” Entity Type. The one or more nested data elements may comprise location information. Location information may be described by a Location Use Code that relates the location information to the entity. For example, a Location Use Code of “Primary” may relate that the location information is the primary address of the mortgage applicant. Location Use Codes may depend on the roles of the entity and other parameters of the transaction. By focusing on the data from the transaction information itself and the relationships therein, operation 602 may provide a robust set of information that may be stored in a single format and reused, thereby efficiently tracking data from plurality of transactions and types of transactions.

In an operation 604, uniform hierarchical information 112 may be generated based on hierarchical data structure 202. In an operation 606, uniform transaction document 114 may be generated based on the uniform hierarchical information 112. In an operation 608, transaction documents 116 may be generated based on uniform transaction document 114. In this manner, uniform transaction document 114 may include some or all data necessary to process, complete, or otherwise provide information related to any relevant transactions 116. Returning to operation 604, if the received transaction information has not been translated, processing may proceed to an operation 608, wherein translation to a standard format may be performed. Processing may proceed to operation 606.

In operation 606, the received transaction information may be processed according to a hierarchical data structure 602. Data from the received transaction information may be categorized. Categories may define a top level of the hierarchical data structure 602. Categories may include, for example, Entities, Underwriting, Collateral, Terms and Provisions, Regulatory, Administrative, and/or other categories.

The hierarchical data structure provides a single data schema for documenting transactions between a customer and a financial institution throughout a variety of localities, allowing single integration of transaction information regardless of local practices. The single integration allows for a financial institution or other party integrating to the data schema to originate consumer loans, commercial loans, portfolio mortgages, conforming mortgages, home equity loans, deposit accounts, retirement or other tax favored deposit accounts, and/or other transactions without the need for multiple, expensive and time-intensive integrations. For example, via the use of roles, data identifying parties to a transaction may be mapped to by the integrating party only once. Thereafter, the same data may be used within all areas of the financial institutions simply by applying different roles and uses to the same data and associating via ID references.

As used herein, the term “document” may include any electronic record (such as a database record, electronic file, etc.), written record (such as a paper instrument, note, etc.), or other suitable medium for recording information related to transactions 102. Furthermore, unless specifically expressed otherwise, use of singular is intended to be plural and vice versa. For example, “document” and “documents” may be used interchangeably.

Various implementations of the invention may be made in hardware, firmware, software-enabled hardware, or any suitable combination thereof. Various implementations of the invention may include software instructions stored on a computer readable medium, which may be read and executed by one or more processors. A computer readable medium may include any tangible mechanism for storing or transmitting information in a form readable by a machine (e.g., a computing device). For example, a computer readable medium may include read only memory, random access memory, magnetic disk storage media, optical storage media, flash memory devices, and other tangible medium. Further, firmware, software, routines, or instructions may be described in the above disclosure in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for processing transaction information comprising:
receiving first transaction information comprising particular transaction data referred to in a first data field of a first transaction document and second transaction information comprising the particular transaction data referred to in a second data field of a second transaction document;
determining the particular transaction data from the received first transaction information and the received second transaction information, wherein the particular transaction data is referred to differently by the first data field and the second data field;
storing the particular transaction data using at least one data element in a uniform hierarchical data structure for facilitating exchange of the particular transaction data; and
generating a transaction document that uses the particular transaction data from the uniform hierarchical data structure.

2. The computer-implemented method of claim 1, further comprising:
determining a first category of information from the first transaction information and a second category of information from the second transaction information, wherein the first category of information comprises the at least one data element.

3. The computer-implemented method of claim 2, further comprising:
generating the hierarchical data structure based on data from the first transaction information and the second transaction information, wherein the first category of information and the second category of information are on a top level of the hierarchical data structure.

4. The computer-implemented method of claim 2, wherein the first category of information comprises all the entities involved in a particular transaction being processed.

5. The computer-implemented method of claim 4, wherein the at least one data element represents a particular entity involved in the particular transaction being processed.

6. The computer-implemented method of claim 5, further comprising:
determining a first role that describes a role played by the particular entity in the particular financial transaction being processing.

7. The computer-implemented method of claim 5, further comprising:
determining a first entity type for the particular entity in the particular transaction being stored, wherein the first entity type describes the particular entity.

8. The computer-implemented method of claim 5, further comprising:
determining first location information associated with the particular entity in the particular transaction being processed; and
determining a location use code for the first location information.

9. The computer-implemented method of claim 8, wherein the first location use code depends on the first role.

10. The computer-implemented method of claim 8, wherein the first location use code depends on the first entity type.

11. A computer-implemented method for generating a transaction document comprising:
determining a type of transaction for which the transaction document is being generated;
retrieving transaction information that is necessary to generate the transaction document based at least in part on the determined type of transaction, wherein the transaction information originated from a prior transaction that was processed according to a uniform hierarchical data structure that facilitates exchange of the transaction information regardless of whether a prior type of the prior transaction and the type of transaction are the same;
determining at least one category of information comprising at least one data element from the retrieved transaction information; and
generating the transaction document based at least in part on the at least one category of information and the at least one data element.

12. A computer-implemented method for reducing redundancy in a hierarchical data structure comprising:
receiving at least one duplicated transaction information,
wherein the at least one duplicated transaction information is redundant across a first transaction data field and a second transaction data field,
wherein the first transaction data field comprises at least one third transaction data field related to the first transaction data field and wherein the second transaction field comprises at least one fourth transaction data field related to the second transaction data field;
receiving the at least one third transaction data field and the at least one fourth transaction data field;
associating the at least one third transaction data field and the at least one fourth transaction data field to the at least one duplicated transaction information,
generating at least one data element in the hierarchical data structure based at least in part on the at least one duplicated transaction information and the association; and
whereby the at least one duplicated transaction information and associated at least one third transaction data field and at least one fourth transaction data field would otherwise be redundantly received.

13. A computer readable medium storing computer executable instructions for processing transaction information, the instructions configuring one or more processors to:
receive first transaction information comprising particular transaction data referred to in a first data field of a first transaction document and second transaction information comprising the particular transaction data referred to in a second data field of a second transaction document;
determine the particular transaction data from the received first transaction information and the received second transaction information, wherein the particular transaction data is referred to differently by the first data field and the second data field; and
refer to the particular transaction data using at least one data element in a uniform hierarchical data structure for facilitating exchange of the particular transaction data, whereby a transaction document that uses the particular transaction data is generated based on the uniform hierarchical data structure.

14. A computer readable medium storing computer executable instructions for generating a transaction document, the instructions configuring one or more processors to:
determine a type of transaction for which the transaction document is being generated;
retrieve transaction information that is necessary to generate the transaction document based at least in part on the determined type of transaction, wherein the transaction information originated from a prior transaction that was processed according to a uniform hierarchical data structure that facilitates exchange of the transaction information regardless of whether a prior type of the prior transaction and the type of transaction are the same;
determine at least one category of information comprising at least one data element from the retrieved transaction information; and
generate the transaction document based at least in part on the at least one category of information and the at least one data element.

15. A computer readable medium storing computer executable instructions for reducing redundancy in a hierarchical data structure, the instructions configuring one or more processors to:
receive at least one duplicated transaction information,
wherein the at least one duplicated transaction information is redundant across a first transaction data field and a second transaction data field,
wherein the first transaction data field comprises at least one third transaction data field related to the first transaction data field and the second transaction field comprises at least one fourth transaction data field related to the second transaction data field;
receive the at least one third transaction data field and the at least one fourth transaction data field;
associate the at least one third transaction data field and the at least one fourth transaction data field to the at least one duplicated transaction information,
generate at least one data element in the hierarchical data structure based at least in part on the at least one duplicated transaction information and the association; and
whereby the at least one duplicated transaction information and associated at least one third transaction data field and at least one fourth transaction data field would otherwise be redundantly received.

16. A system for processing transaction information comprising:
one or more processors configured to:
receive first transaction information comprising particular transaction data referred to in a first data field of a first transaction document and second transaction information comprising the particular transaction data referred to in a second data field of a second transaction document;
determine the particular transaction data from the received first transaction information and the received second transaction information, wherein the particular transaction data is referred to differently by the first data field and the second data field; and
refer to the particular transaction data using at least one data element in a uniform hierarchical data structure for facilitating exchange of the particular transaction data, whereby a transaction document that uses the particular transaction data is generated based on the uniform hierarchical data structure.

17. A system for generating a transaction document comprising:
one or more processors configured to:
determine a type of transaction for which the transaction document is being generated;
retrieve transaction information that is necessary to generate the transaction document based at least in part on the determined type of transaction, wherein the transaction information originated from a prior transaction that was processed according to a uniform hierarchical data structure that facilitates exchange of the transaction information regardless of whether a prior type of the prior transaction and the type of transaction are the same;
determine at least one category of information comprising at least one data element from the retrieved transaction information; and
generate the transaction document based at least in part on the at least one category of information and the at least one data element.

18. A system for reducing redundancy in a hierarchical data structure comprising:
one or more processors configured to:
receive at least one duplicated transaction information,
wherein the at least one duplicated transaction information is redundant across a first transaction data field and a second transaction data field,
wherein the first transaction data field comprises at least one third transaction data field related to the first transaction data field and the second transaction field comprises at least one fourth transaction data field related to the second transaction data field;
receive the at least one third transaction data field and the at least one fourth transaction data field;
associate the at least one third transaction data field and the at least one fourth transaction data field to the at least one duplicated transaction information,
generate at least one data element in the hierarchical data structure based at least in part on the at least one duplicated transaction information and the association; and
whereby the at least one duplicated transaction information and associated at least one third transaction data field and at least one fourth transaction data field would otherwise be redundantly received.
